(19) United States
(12) Patent Application Publication
(10) Pub. No.: US 2025/0199144 A1
(43) Pub. Date: Jun. 19, 2025

(54) SENSOR MODULE AND ELECTRONIC DEVICE COMPRISING SAME

(71) Applicant: SAMSUNG ELECTRONICS CO., LTD., Suwon-si (KR)

(72) Inventor: Dosung Jung, Suwon-si (KR)

(73) Assignee: SAMSUNG ELECTRONICS CO., LTD., Suwon-si (KR)

(21) Appl. No.: 19/005,429

(22) Filed: Dec. 30, 2024

Related U.S. Application Data
(63) Continuation of application No. PCT/KR2024/018539, filed on Nov. 21, 2024.

(30) Foreign Application Priority Data
Dec. 18, 2023 (KR) 10-2023-0184912

(51) Int. Cl. G01S 7/497; G01S 7/481; G01S 17/08

(52) U.S. Cl. CPC G01S 7/4972; G01S 7/4811; G01S 17/08

(57) ABSTRACT

An electronic device may include: a main body; a driving device configured to move the main body; and a sensor module including: at least one sensor; a support that supports the at least one sensor; a sensor module body fixing the sensor module to the main body; a hinge part that rotatably connects the support and the sensor module body, wherein the hinge part includes: a first hinge rotatably supporting the support on sides of the support with respect to a front direction of the main body; and a second hinge rotatably supporting the support on a rear side of the support with respect to the front direction of the main body; and a balance element that is disposed on a lower side of the support, and configured to maintain a balance of the support while the main body is moved by the driving device.

### CROSS-REFERENCE TO RELATED APPLICATION

This application is a continuation application, under 35 U.S.C. § 111 (a), of international application No. PCT/KR2024/018539, filed on Nov. 21, 2024, which claims priority under 35 U. S. C. § 119 to Korean Patent Application No. 10-2023-0184912, filed on Dec. 18, 2023, the disclosures of which are incorporated herein by reference in their entireties.

### BACKGROUND

### 1. Field

The disclosure relates to a sensor module and an electronic device comprising the same. Specifically, the disclosure relates to a sensor module that maintains balance during moving, and an electronic device comprising the same.

### 2. Description of the Related Art

Recently, use of electronic devices equipped with a moving function such as a robot cleaner, a movable projector, etc. is increasing. Such electronic devices may alternatively be called driving robots. A driving robot is a device that performs various types of tasks while autonomously moving in an area to be driven without a user's manipulation. Recently, driving robots utilized in various fields as sensors and controllers have been developed. As examples of driving robots, there are a cleaning robot, a telepresence robot, a security robot, etc.

A driving robot may be manufactured in various forms. In case a driving robot is implemented with the body of the driving robot being supported by a plurality of wheels, and the driving robot driving by rotation of the wheels, the body of the driving robot may be tilted by inertia when the driving robot accelerates or decelerates. For example, the body of the driving robot may rotate in a pitch angle direction or a roll angle direction.

In case a sensor is embedded in a body of a robot, the sensor rotates together by the rotation of the body. In this case, the sensing direction may vary.

For example, in case the sensor is a LiDAR sensor, if the LiDAR sensor rotates during sensing, a problem that a correct result cannot be obtained through a sensing value obtained through the LiDAR sensor.

### SUMMARY

According to one or more example embodiments, an electronic device may include: a main body; a driving device configured to move the main body; and a sensor module including: at least one sensor; a support that supports the at least one sensor; a sensor module body fixing the sensor module to the main body; a hinge part that rotatably connects the support and the sensor module body, wherein the hinge part includes: a first hinge rotatably supporting the support on sides of the support with respect to a front direction of the main body; and a second hinge rotatably supporting the support on a rear side of the support with respect to the front direction of the main body; and a balance element that is disposed on a lower side of the support, and configured to maintain a balance of the support while the main body is moved by the driving device.

According to one or more example embodiments, a method of controlling an electronic device including a sensor module, may include: detecting a tilt of the sensor module based on a sensing value of a tilt detection sensor disposed in the sensor module during moving of the electronic device; and maintaining a balance of the sensor module by applying an electric signal to at least one of a plurality of electromagnets in the sensor module. The sensor module may include: a support supporting at least one sensor including the tilt detection sensor; a sensor module body fixing the sensor module to a main body of the electronic device; a hinge part that rotatably connects the support and the sensor module body; and a balance element that is disposed on a lower side of the support, and is configured to maintain a balance of the support while the main body is moving by the driving device.

According to one or more example embodiments, a sensor module for mounting on an electronic device, may include: a support supporting at least one sensor, a sensor module body fixing the sensor module to a main body of the electronic device; a hinge part that rotatably connects the support and the sensor module body; and a balance element that is disposed on a lower side of the support, and is configured to maintain a balance of the support while the electronic device is moving. The hinge part may include: a first hinge that rotatably supports the support on both sides of the support based on a front direction of the electronic device; and a second hinge that rotatably supports the support on a rear side of the support based on the front direction of the electronic device.

### BRIEF DESCRIPTION OF THE DRAWINGS

Embodiments will be more clearly understood from the following detailed description taken in conjunction with the accompanying drawings in which:

FIG. 1 is a perspective view for illustrating an exterior of an electronic device according to one or more embodiments of the disclosure;

FIG. 2 is a block diagram for illustrating a configuration of an electronic device according to one or more embodiments of the disclosure;

FIG. 3 is a diagram for illustrating rotation of a body when an electronic device accelerates in the front direction of the body according to one or more embodiments of the disclosure;

FIG. 4 is a diagram for illustrating rotation of a body when an electronic device accelerates in the rear direction of the body according to one or more embodiments of the disclosure;

FIG. 5A is a diagram illustrating a situation wherein a roll angle of a body of an electronic device changes according to one or more embodiments of the disclosure;

FIG. 5B is a diagram illustrating a situation wherein a roll angle of a body of an electronic device changes according to one or more embodiments of the disclosure;

FIG. 6A is a diagram illustrating a situation wherein a roll angle of a body of an electronic device changes according to one or more embodiments of the disclosure;

FIG. 6B is a diagram illustrating a situation wherein a roll angle of a body of an electronic device changes according to one or more embodiments of the disclosure;

FIG. 7A is a perspective view of a sensor module according to one or more embodiments of the disclosure;

FIG. 7B is a perspective view for illustrating a sensor module mounted on a body according to one or more embodiments of the disclosure;

FIG. 7C is a cross-sectional view for illustrating a sensor module mounted on a body according to one or more embodiments of the disclosure;

FIG. 8 is a diagram for illustrating a method for an electronic device to maintain balance of a sensor when a pitch angle of a body 10 changes according to one or more embodiments of the disclosure;

FIG. 9 is a diagram for illustrating a method for an electronic device to maintain balance of a sensor when a pitch angle of a body 10 changes according to one or more embodiments of the disclosure;

FIG. 10A is a diagram for illustrating a method for an electronic device to maintain balance of a sensor when a body is tilted in a roll angle direction according to one or more embodiments of the disclosure;

FIG. 10B is a diagram for illustrating a method for an electronic device to maintain balance of a sensor when a body is tilted in a roll angle direction according to one or more embodiments of the disclosure;

FIG. 11A is a diagram for illustrating a method for an electronic device to maintain balance of a sensor when a body is tilted in a roll angle direction according to one or more embodiments of the disclosure;

FIG. 11B is a diagram for illustrating a method for an electronic device to maintain balance of a sensor when a body is tilted in a roll angle direction according to one or more embodiments of the disclosure;

FIG. 12 is a flow chart for illustrating a method for an electronic device to maintain balance of a support part by rotating the support part by using an electromagnet or a rotation motor according to one or more embodiments of the disclosure;

FIG. 13 is a diagram for illustrating a method for an electronic device to rotate a sensor in a reverse direction when the sensor rotates in the rear direction of the body according to one or more embodiments of the disclosure;

FIG. 14 is a diagram for illustrating a method for an electronic device to rotate a sensor in the rear direction of the body when the sensor rotates in the front direction of the body according to one or more embodiments of the disclosure;

FIG. 15 is a diagram for illustrating a method for an electronic device to rotate a sensor in a reverse direction when the sensor rotates in the right direction of the body according to one or more embodiments of the disclosure;

FIG. 16 is a diagram for illustrating a method for an electronic device to rotate a sensor in a reverse direction when the sensor rotates in the left direction of the body according to one or more embodiments of the disclosure;

FIG. 17 is a diagram for illustrating a rotation motor according to one or more embodiments of the disclosure;

FIG. 18A is a diagram for illustrating a projector part according to one or more embodiments of the disclosure; and

FIG. 18B is a diagram for illustrating a projector part according to one or more embodiments of the disclosure.

### DETAILED DESCRIPTION OF EMBODIMENTS

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents, and/or alternatives of the embodiments of the disclosure. Meanwhile, with respect to the detailed description of the drawings, similar components may be designated by similar reference numerals.

Also, in case it is determined that in describing the disclosure, detailed explanation of related known functions or features may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, the terms used in the disclosure are used only to explain specific embodiments, and are not intended to limit the scope of the disclosure. In addition, singular expressions include plural expressions, unless defined obviously differently in the context.

Also, in the disclosure, expressions such as “have,” “may have,” “include,” and “may include” denote the existence of such characteristics (e.g.: elements such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor for performing the corresponding operations, or a generic-purpose processor (e.g.: a CPU or an application processor) that can perform the corresponding operations by executing one or more software programs stored in a memory device.

Also, in the embodiments of the disclosure, ‘a module’ or ‘a part’ may perform at least one function or operation, and may be implemented as hardware or software, or as a combination of hardware and software. In addition, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in drawings were illustrated schematically. Accordingly, the technical idea of the disclosure is not limited by the relative sizes or intervals illustrated in the accompanying drawings.

Hereinafter, embodiments according to the disclosure will be described in detail with reference to the accompanying drawings, such that those having ordinary skill in the art to which the disclosure belongs can easily carry out the disclosure.

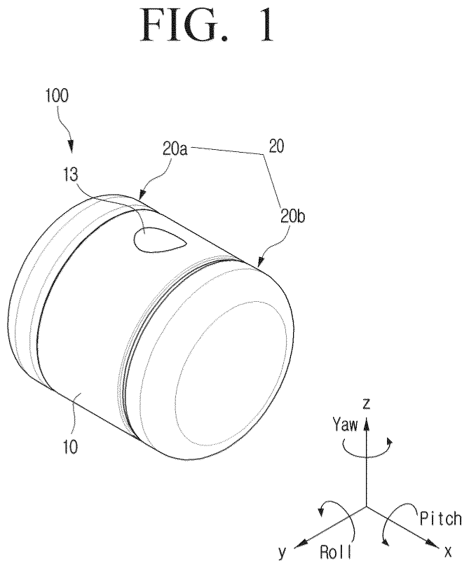

FIG. 1 is a perspective view for illustrating an exterior of an electronic device according to one or more embodiments of the disclosure.

The electronic device 100 may be a device that can move (e.g. self-driving). Alternatively, the electronic device 100 may be referred to as various names such as an autonomous driving device, a driving robot, a movable device, etc. The electronic device 100 in FIG. 1 may be classified in various ways according to its functions. For example, in case the electronic device 100 includes a beam projector, the electronic device 100 may be a movable projector. Alternatively, in case the electronic device 100 includes a dry cleaning module or a wet cleaning module, the electronic device 100 may be a cleaning robot, and in case it includes a shelf supporting objects, etc., the electronic device 100 may be a robot for serving.

Referring to FIG. 1, the electronic device 100 includes a body 10 and a driving device 20.

The body 10 is a component forming the exterior of the electronic device 100. In FIG. 1, shows a body 10 with a cylindrical shape, but the disclosure is not necessarily limited thereto, and the body 10 may be modified into various shapes such as a spherical shape or a disk shape, etc.

One side surface of the body 10 may include an opening 13. Here, the opening 13 may be an opening that can be opened or closed, or may always be in open. A sensor module 30 may be mounted inside the opening 13. The sensor module may include at least one sensor for sensing various kinds of information such as the location of the electronic device 100 and a distance from an ambient obstacle, etc. In the sensor module, various types of sensors such as a LiDAR sensor, an IR sensor, an image sensor, an ultrasonic sensor, a tilt detection sensor, etc. may be included. Detailed explanation in this regard will be described again below.

Meanwhile, the sensor module 30 according to the disclosure may also be referred to as a balancing module or a level maintenance module, and does not necessarily include a sensor. Specifically, the sensor module 30 may support various elements for which level maintenance is necessary such as a sensor, etc., and may maintain the level of a supported element.

In order that the sensor module 30 can correctly sense the ambient environment, the opening 13 may be in a location wherein it can observe the entire ambient 360 degrees around the body 10. FIG. 1 illustrates a case wherein the opening 13 is in the upper part of the body 10. If the sensor module is mounted inside the opening 13, the opening 13 may be covered by a transparent cover. Accordingly, a phenomenon wherein dust or other foreign substances are stuck in the sensor module and its surroundings can be prevented. The cover that covers the opening 13 may be flat with respect to the ambient surface of the opening 13, or may be manufactured by bulging a material up convexly compared to the ambient surface.

The driving device 20 is a component for moving the electronic device 100. The driving device 20 may include a moving element for moving the electronic device 100. For example, the moving element may include a plurality of wheels, a ball, a rail, etc. The driving device 20 may include at least one motor, at least one axis for transmitting the force of the motor to other components, and a gear, etc. The driving device 20 may be controlled by the processor, and transmit a physical force to each hardware component constituting the driving device 20.

Referring to FIG. 1, the driving device 20 may include two wheels 20a, 20b. In FIG. 1, a case in which the two wheels 20a, 20b are attached on both side surfaces of the body 10 was illustrated, but the number, the shape, the attached location, etc. of the wheels may be changed in various ways.

The driving device 20 may make the electronic device 100 go forward by rotating the two wheels simultaneously in a first direction, or make the electronic device 100 go backward by rotating the two wheels in a second direction which is opposite to the first direction. Alternatively, the driving device 20 may rotate the electronic device 100 in a clockwise direction or a counter-clockwise direction by rotating only one of the two wheels, or varying the rotation speed of the two wheels. That is, the driving device 20 may rotate the electronic device 100 such that a yaw angle is changed based on the bottom surface on which the electronic device 100 is placed.

If the driving device 20 moves the electronic device 100, the body 10 may be tilted such that a pitch angle and/or a roll angle change by inertia.

In the disclosure, a pitch angle, a roll angle, and a yaw angle may mean angles of rotating based on a pitch axis, a roll axis, and a yaw axis.

Referring to FIG. 1, the pitch axis x may be an axis perpendicular to a proceeding direction of the electronic device 100 based on the bottom surface on which the electronic device 100 is placed. That is, the pitch axis x may be an axis for indicating a front-rear tilt or a front-rear rotation of the electronic device 100.

The roll axis y may be an axis parallel to a proceeding direction of the electronic device 100. That is, the roll axis y may be an axis for indicating a left-right tilt or a left-right rotation of the electronic device 100. A plane constituted by the pitch axis x and the roll axis y may be a surface parallel to the bottom surface.

The yaw axis z may be an axis perpendicular to the plane constituted by the pitch axis x and the roll axis y or the bottom surface. As in FIG. 1, in case the main body 10 is supported by the two wheels 20a, 20b, if the electronic device 100 drives, the body 10 may be tilted such that the pitch angle changes in the moving direction or an opposite direction thereof, or the body 10 may be tilted such that the roll angle changes in a rotating process.

In this case, as the sensor module mounted inside the opening 13 is also tilted together with the body 10, a sensing direction or an angle of each sensor mounted on the sensor module may be changed. Accordingly, correct sensing for the ambient environment cannot be performed, and thus there is a possibility that the electronic device 100 may collide with an obstacle or move to a wrong location during moving.

For preventing such a phenomenon, a balance element may be provided in the sensor module. The balance element performs a role of maintaining the balance of the sensor module while the body 10 of the electronic device is moving.

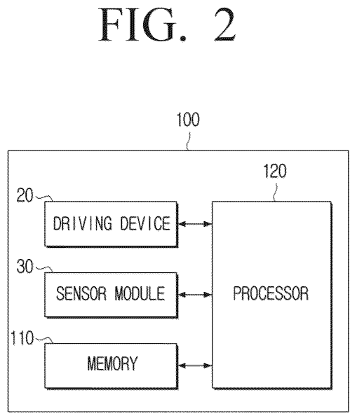

The detailed configuration and operation of the electronic device 100 will be explained with reference to FIG. 2.

FIG. 2 is a block diagram for illustrating a configuration of an electronic device according to one or more embodiments of the disclosure. According to FIG. 2, the electronic device 100 may include a driving device 20, a sensor module 30, a memory 110, and a processor 120.

The driving device 20 includes a motor for rotating the wheels 20a, 20b as described above. The motor may be driven according to control by the processor 120. In FIG. 2, it was illustrated that the driving device 20 is directly connected with the processor 120 and receives a control signal, but the motor of the driving device 20 may receive a control signal from separate driving circuitry that is driven according to an instruction of the processor 120, and may be driven based on the control signal. The rotating direction or the rotating speed, etc. of the motor may be changed according to such a control signal.

The sensor module 30 may include at least one sensor. The sensor module 30 may include various sensors such as a LiDAR sensor, an image sensor, an IR sensor, an ultrasonic sensor, etc.

Alternatively, the sensor module 30 may include a sensor for detecting a rotation of the sensor module 30 itself or the body 10. For example, the sensor module 30 may further include a tilt detection sensor. The tilt detection sensor may be implemented as various sensors such as an acceleration sensor, a gyro sensor, a geomagnetic sensor, an inertia detection sensor, etc.

The memory 110 may be a component for storing various kinds of software, instructions, data, etc. necessary for the operations of the electronic device 100.

In FIG. 2, a case in which the memory 110 was implemented as separate memory from the processor 120 was illustrated. However, the disclosure is not necessarily limited thereto, and the memory 110 may be implemented as internal memory such as ROM (e.g., electrically erasable programmable read-only memory (EEPROM)), RAM, etc. included in the processor 120.

Alternatively, the memory 110 may be implemented by memory embedded in the electronic device 100, or implemented by memory that can be attached to or detached from the electronic device 100 according to the usage of stored data. For example, in the case of data for operating the electronic device 100, the data may be stored in memory embedded in the electronic device 100, and in the case of data for an extended function of the electronic device 100, the data may be stored in memory that can be attached to or detached from the electronic device 100.

In the case of memory embedded in the electronic device 100, the memory 110 may be implemented as at least one of volatile memory 110 (e.g.: dynamic RAM (DRAM), static RAM (SRAM), or synchronous dynamic RAM (SDRAM), etc.) or non-volatile memory 110 (e.g.: one time programmable ROM (OTPROM), programmable ROM (PROM), erasable and programmable ROM (EPROM), electrically erasable and programmable ROM (EEPROM), mask ROM, flash ROM, flash memory 110, a hard drive, or a solid state drive (SSD)).

In the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory 110 that can be connected to a USB port, etc.

As described above, in the memory 110, various kinds of software, data, etc. may be stored as well as at least one instruction regarding the electronic device 100. Also, in the memory 110, an operating system (O/S) for driving the electronic device 100 may be stored. Other than the above, in the memory 110, various kinds of software programs or applications for the electronic device 100 to operate according to the various embodiments of the disclosure may be stored. The processor 120 may control the operations of the electronic device 100 by executing the various kinds of software modules stored in the memory 110. That is, the memory 110 may be accessed by the processor 120, and reading/recording/correction/deletion/update, etc. of data by the processor 120 may be performed.

In the disclosure, the term memory 110 may be used as a meaning including a storage part, ROM and RAM inside the processor 120, or a memory card installed on the electronic device 100 (e.g., a micro SD card, a memory stick).

The processor 120 is a component for controlling the overall operations of the electronic device 100. The processor 120 may include one or more of a digital signal processor processing digital signals, a microprocessor, a central processing unit (CPU), a micro controller unit (MCU), a micro processing unit (MPU), a controller, an application processor 120, a graphics-processing unit (GPU) or a communication processor 120, and an advanced reduced instruction set computer (RISC) machines (ARM) processor, or may be defined by the terms. Also, the processor 120 may be implemented as a system on chip (SoC) having a processing algorithm stored therein or large scale integration (LSI), or implemented by a field programmable gate array (FPGA). Further, the processor 120 may perform various functions by executing computer executable instructions stored in the memory 110.

As described above, the electronic device 100 may be implemented in various types, and the processor 120 may perform various operations depending on implementation examples.

For example, in case the electronic device 100 is implemented as a movable projector including a projector part, the processor 120 may identify the location of the electronic device 100 within the space in which the electronic device 100 is placed based on a sensing value of the sensor module 30. Specifically, in case a LiDAR sensor is included in the sensor module 30, the processor 120 may control the LiDAR sensor such that the LiDAR sensor irradiates laser while rotating in 360 degrees with respect to the space in which the electronic device 100 is located. If the laser is reflected from an object around the electronic device 100 and is received at the LiDAR sensor again, the LiDAR sensor may sense the time of irradiation of the laser and the time of reception, the strength of reception of the laser signal, etc., and provide them to the processor 120.

The processor 120 may measure a distance from an object based on a sensing value of the LiDAR sensor, and generate data points of an ambient space by performing such distance measurement in various angles and directions. The processor 120 may collect such data points by a point cloud. Each point includes information on a coordinate value for expressing a location in a space. Here, the point cloud may include information on a 2D coordinate value or information on a 3D coordinate value.

The processor 120 may generate a 2D map or a 3D map for the space in which the electronic device 100 is placed based on the point cloud data. However, the disclosure is not limited to this example, and the processor 120 may generate a map by using various known technologies other than this. Also, in case an image sensor or an IR sensor, etc. are further included in the sensor module 30, the processor 120 may improve the precision of the map based on sensing values of such sensors. The processor 120 may store data for the generated map in the memory 110.

In such a state, the processor 120 may perform various operations while moving in a space based on the map data. As in the aforementioned example, in case the electronic device 100 is implemented as a movable projector, the processor 120 selects a projection surface based on the map data, and controls the driving device 20 to move the body 10 to a location spaced from the projection surface by a predetermined distance. When the body 10 moves to the location, the processor 120 reproduces content data, and controls the projector part 240 to project the content in the direction of the projection surface.

Meanwhile, in case the electronic device 100 is implemented as a robot cleaner, the processor 120 identifies the entire areas that can be cleaned within a space based on the map data, and then sets a moving route for moving in the entire areas, and controls the driving device 20 to move the body 10 according to the moving route. The processor 120 may drive a dry cleaning module to suck in foreign substances such as dust, etc. during moving, or drive a wet cleaning module to rotate a mopping pad to which a wet mop is attached.

In case the electronic device 100 is implemented as a robot for serving, the processor 120 identifies each of the location of the electronic device 100, and a destination of serving in a space based on the map data, and sets a moving route to the destination of serving, and then controls the driving device 20 to move the body 10 according to the moving route.

The processor 120 may identify an ambient situation by frequently or periodically receiving sensing values of the sensor module 30 to prevent collision with an ambient obstacle during moving. Accordingly, if the sensor module 30 is tilted together with the body 10, the map data may be generated to be incorrect, or measurement of a distance to an ambient obstacle, a possibility of collision, etc. cannot be determined correctly. For preventing such situations, in the various embodiments of the disclosure, a configuration for maintaining the balance of the sensor module 30 is further included. Such a configuration and its actions and operations will be described in detail again in the parts described below.

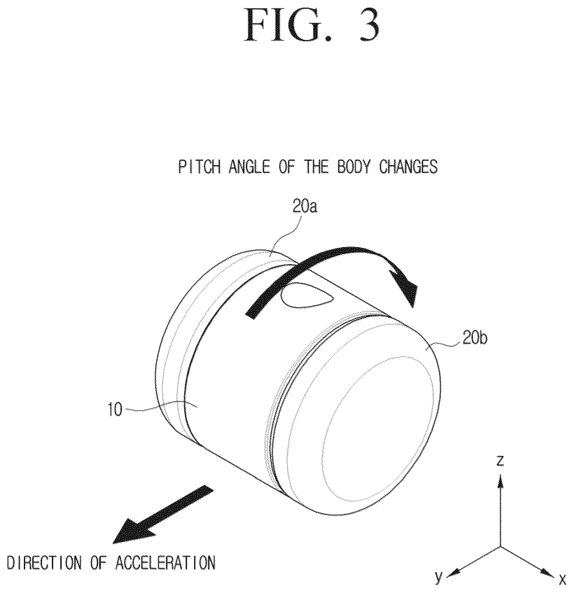

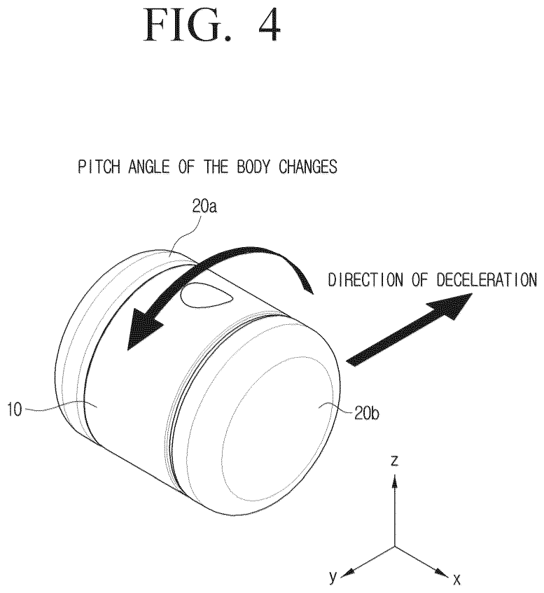

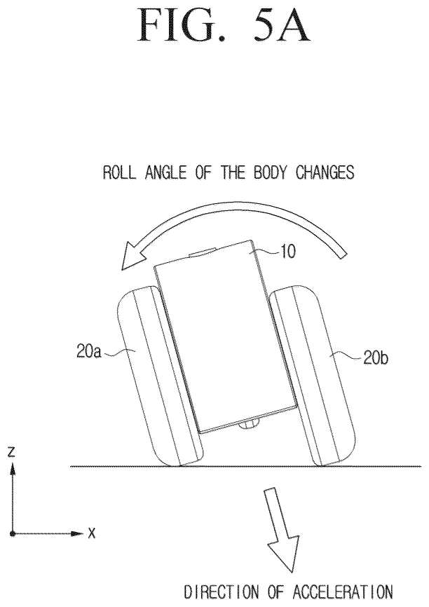

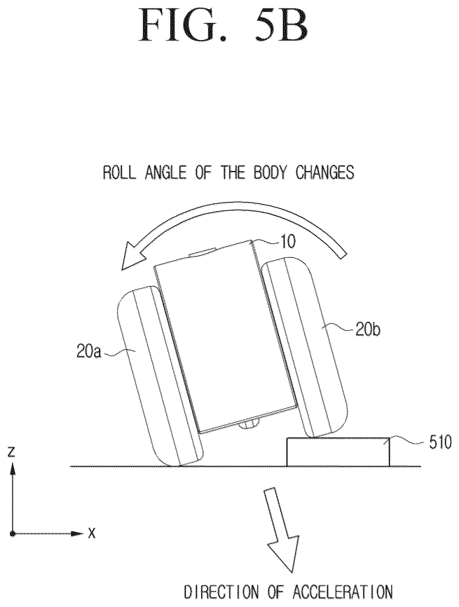

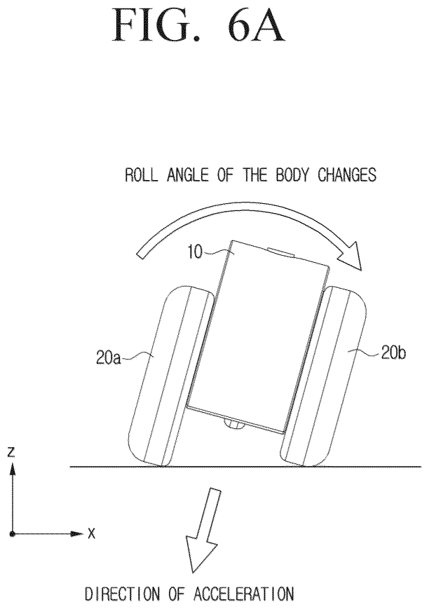

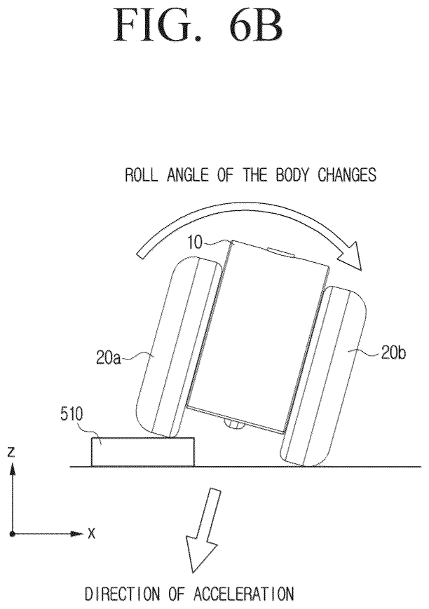

In FIG. 1, a case in which one memory 110 and one processor 120 are respectively included in the electronic device 100 was illustrated, but the disclosure is not necessarily limited thereto, and there may be a plurality of memories 110 and processors 120. Also, at least one of the plurality of memories 110 and processors 120 may be mounted on the sensor module 30. A phenomenon in which the body 10 rotates as the electronic device 100 moves will be explained with reference to FIG. 3, FIG. 4, FIG. 5, and FIG. 6.

FIG. 3 is a diagram for illustrating rotation of the body 10 when the electronic device 100 accelerates in the front direction of the body 10 according to one or more embodiments of the disclosure. The front direction may be one side among directions perpendicular to the arrangement direction of the wheels in a structure in which the wheels 20a, 20b are arranged in parallel on both sides of the body 10, and the rear direction may be the opposite direction thereof. In case the electronic device 100 is implemented as a movable projector, the direction in which the projector part is arranged may be the front direction, and the opposite direction thereof may be the rear direction among the directions perpendicular to the arrangement direction of the wheels. However, such distinction is merely for the convenience of explanation, and alternatively, the front direction may be referred to as a moving direction, a forward proceeding direction, or a normal moving direction of the electronic device 100, and the rear direction may be referred to as a backward proceeding direction or a reverse moving direction of the electronic device 100.

Referring to FIG. 3, in case the electronic device 100 accelerates in the front direction of the body 10 (i.e., the direction of the arrow), the pitch angle of the body 10 may change as the body 10 is tilted in the rear direction according to the moving speed. That is, the body 10 may rotate in the −y axis direction based on the x axis. According to the speed of acceleration, change of the pitch angle may become bigger.

FIG. 4 is a diagram for illustrating rotation of the body 10 when the electronic device 100 accelerates in the rear direction of the body 10 according to one or more embodiments of the disclosure.

Referring to FIG. 4, if the electronic device 100 stops abruptly or decelerates abruptly while moving in the front direction of the body 10, or moves in the rear direction of the body 10, the pitch angle of the body 10 may change as the body 10 is tilted in the front direction. That is, the body 10 may rotate in the +y axis direction based on the x axis. Meanwhile, the polarity of the pitch angle when the body 10 rotates in the −y axis direction and the polarity of the pitch angle when the body 10 rotates in the +y axis direction may be opposite to each other.

For example, in the disclosure, if the body 10 rotates in the +y axis direction based on the x axis, change of the pitch angle of the body 10 may have a positive value. That is, if the body 10 rotates in the front direction of the body 10, the pitch angle of the body 10 may change in a positive direction.

Also, if the body 10 rotates in the −y axis direction based on the x axis, change of the pitch angle of the body 10 may have a negative value. That is, if the body 10 rotates in the rear direction of the body 10, the pitch angle of the body 10 may change in a negative direction.

In addition, the polarity of the roll angle when the body 10 rotates in the −x axis direction and the polarity of the roll angle when the body 10 rotates in the +x axis direction may be opposite to each other.

For example, in the disclosure, if the body 10 rotates in the −x axis direction based on the y axis, change of the roll angle of the body 10 may have a positive value. That is, if the body 10 rotates in the right direction of the body 10, the roll angle of the body 10 may change in a positive direction.

Also, if the body 10 rotates in the +x axis direction based on the y axis, change of the roll angle of the body 10 may have a negative value. That is, if the body 10 rotates in the left direction of the body 10, the roll angle of the body 10 may change in a negative direction.

Meanwhile, the polarity of the pitch angle is not necessarily limited to the above, and accordingly, in the disclosure, the polarity of the pitch angle when the body 10 rotates in the +y axis direction is referred to as the first polarity, and the polarity of the pitch angle when the body 10 rotates in the −y axis direction is referred to as the second polarity. Such definition regarding the polarity can be applied identically to the roll angle or the yaw angle.

FIG. 5A, FIG. 5B, FIG. 6A, and FIG. 6B are diagrams for illustrating a situation in which a roll angle of the body 10 of the electronic device 100 changes according to one or more embodiments of the disclosure.

Referring to FIG. 5A, if the electronic device 100 rotates to the right side of the body 10 and is tilted to the side of the right wheel 20a, the roll angle of the body 10 may change as the body 10 is tilted. FIG. 5A illustrates a state in which the roll angle of the body 10 changes as the body 10 is tilted in the −x axis direction based on the y axis.

Such a situation may also occur while one of the wheels 20a, 20b on both sides passes through an obstacle (e.g., a carpet).

Specifically, referring to FIG. 5B, in case the electronic device 100 drives on a bottom surface which is not flat and on which an obstacle 510 is located, the roll angle of the body 10 may change as the body 10 is tilted. In FIG. 5B, as the left wheel 20b of the body 10 passes over the obstacle 510, the body 10 is tilted in the −x axis direction based on the y axis, and the roll angle of the body 10 may change.

FIG. 6A and FIG. 6B illustrate a state in which the body 10 is tilted in an opposite direction to the direction in FIG. 5A and FIG. 5B.

Referring to FIG. 6A, if the body 10 of the electronic device 100 is tilted in the +x axis direction based on the y axis, the roll angle of the body 10 changes. Alternatively, referring to FIG. 6B, in case the right wheel 20a based on the front side of the electronic device 100 passes over the obstacle 510 (e.g., a carpet), the roll angle of the body 10 may change as the body 10 is tilted in the +x axis direction based on the y axis.

A rotation in the pitch angle direction and a rotation in the roll angle direction of the body 10 may occur together. For example, in case the electronic device 100 drives toward the right front side of the body 10, the pitch angle of the body 10 may change as the body 10 is tilted in the −y axis direction based on the x axis, and the roll angle of the body 10 may change as the body 10 is tilted in the −x axis direction based on the y axis.

As described above, while the electronic device 100 is moving, the body 10 may rotate in the pitch angle direction and/or the roll angle direction. Here, the sensor module 30 included in the body 10 may rotate in the pitch angle direction and/or the roll angle direction together according to the movement of the body 10. In this case, a problem that a sensing value of the sensor included in the sensor module 30 is distorted may occur.

The electronic device 100 according to one or more embodiments of the disclosure may include a sensor module 30 implemented by a separate module, such that the sensors are not tilted together with the body 10. However, the disclosure is not limited thereto, and the sensor module 30 may also be implemented by being embedded in the body 10 of the electronic device 100.

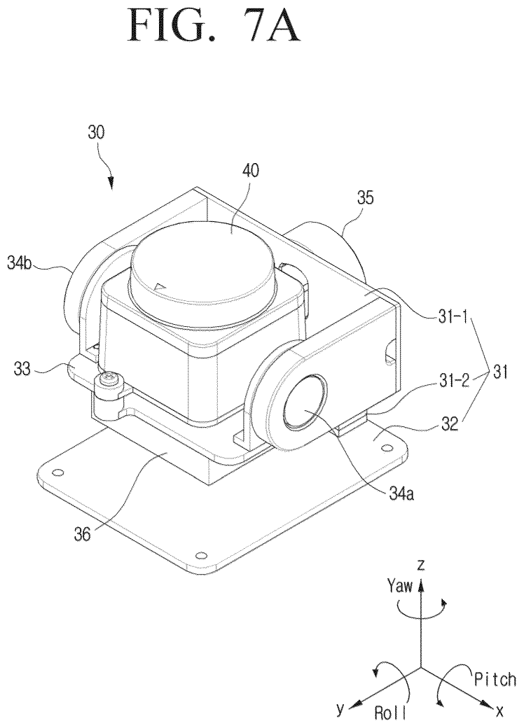

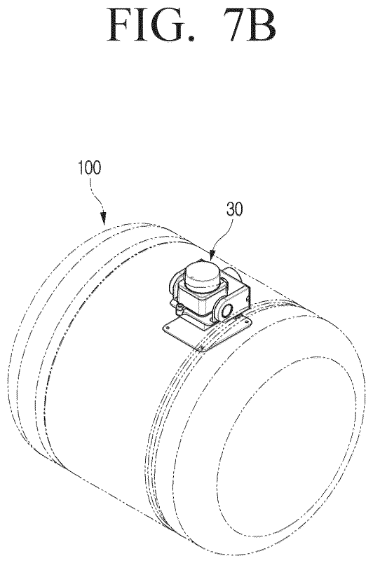

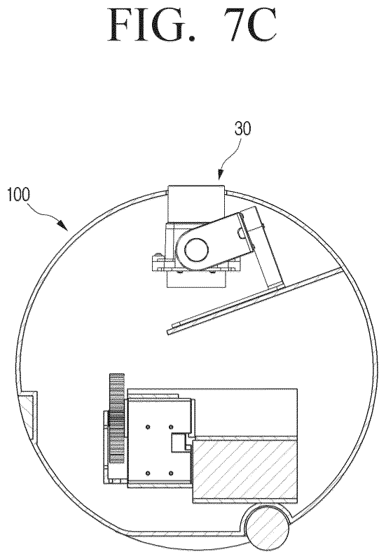

The sensor module 30 can maintain the balance even in case the body 10 is tilted. The configuration of the sensor module 30 that can maintain the balance will be described with reference to FIG. 7.

FIG. 7A is a perspective view of the sensor module 30 according to one or more embodiments of the disclosure.

Referring to FIG. 7A, the sensor module 30 may include a support part 33 for supporting the sensor 40, a body part 31 for fixing the sensor module 30 to the body 10, hinge portions 34a, 34b, 35 connecting the support part 33 and the body part 31 in a rotatable state, and a balance element 36.

The body part 31 may be a component that forms a part of the exterior of the sensor module 30, and fixes the sensor module 30 to the body 10.

The body part 31 may include a fixed plate 32 that can be fixed to the body. In FIG. 7, the fixed plate 32 was illustrated by a plane, but the form or the size of the fixed plate 32 may be modified in various ways. The fixed plate 32 may be fixed to the body 10 by a fastening means such as a bolt, etc., but is not necessarily limited thereto, and it may also be fixed by being inserted into a groove provided on the body 10, or by being attached by a bonding material.

The body part 31 may include a first body part 31 and a second body part 31. The first body part 31 is a part in which the first hinge 34a, 34b is disposed among the hinge parts 34a, 34b, 35, and the second body part 31 is a part in which the second hinge 35 is disposed.

The first hinge 34a, 34b supports the support part 33 in a rotatable state on both sides of the support part 33. That is, the first hinge 34a, 34b supports the support part 33 in a state in which the support part 33 can rotate in the pitch angle direction.

The balance element 36 is arranged on the lower side of the support part 33, and performs a role of maintaining the balance of the support part 33 while the body 10 is moving. The balance element 36 can maintain the center of gravity of the support part 33, as it was manufactured to be heavier than the weight of the sensor 40 mounted on the upper side of the support part 33.

As the balance element 36 is arranged on the lower side of the support part 33, the support part 33 on which the sensor 40 is mounted may maintain the pitch angle, or minimize change of the pitch angle by rotating by the first hinge 34a, 34b, even when the fixed plate 32 rotates together while being interlocked with the body 10.

The first body part 31 is connected with the second body part 31 by the second hinge 35 while the first hinge 34a, 34b is disposed. The second body part 31 may support the first body part 31 in a rotatable state in the roll angle direction by using the second hinge 35. The second body part 31 may be supported by the fixed plate 32. In such a configuration, even if the body 10 is tilted to the left side or the right side such that the roll angle of the body 10 changes, the balance element 36 can maintain the center of gravity of the support part 33. As a result, the first body part 31 may rotate by the second hinge 35 in a space between the second body part 31, and may thereby maintain the roll angle of the sensor 40 mounted on the support part 33, or minimize change of the roll angle.

As described above, the sensor module 30 can maintain the balance without being greatly influenced by the tilt of the body 10 while it is fixed to the body 10.

FIG. 7B is a perspective view for illustrating the sensor module 30 mounted on the body 10 according to one or more embodiments of the disclosure.

FIG. 7C is a cross-sectional view for illustrating the sensor module 30 mounted on the body 10 according to one or more embodiments of the disclosure.

Referring to FIG. 7B and FIG. 7C, at least a portion of the sensor module 30 mounted inside the body 10 may protrude to the outside of the body 10 through an opening 13 disposed on one side surface of the body 10 (e.g., the upper part of the body 10). Accordingly, the sensor included in the sensor module 30 may sense the entire ambient 360 degrees around the body 10.

Here, the fixed plate 32 may be connected to one element 11 inside the body 10. Accordingly, when the body 10 rotates, the body part 31 may rotate following the body 10.

According to one or more embodiments of the disclosure, as the body 10 rotates, the opening 13 may also rotate together. Here, as the size of the opening 13 is bigger than that of the sensor 40 of the sensor module 30, even if the body 10 and the opening 13 rotate, a portion of the sensor 40 of the sensor module 30 maintaining the balance may protrude to the outside of the body 10 and sense the outside environment of the body 10.

Alternatively, even if the body 10 rotates, the opening 13 may not rotate following the body 10, but change according to the location of the sensor module 30. That is, even if the body 10 rotates, if the sensor module 30 maintains the balance, the opening 13 may maintain the balance following the sensor module 30.

Also, in case the body 10 rotates as the electronic device 100 drives, the pitch angle or the roll angle of the sensor module 30 may not change, or change of the angles can be minimized through the balance element 36. Detailed explanation in this regard will be described below with reference to the drawings.

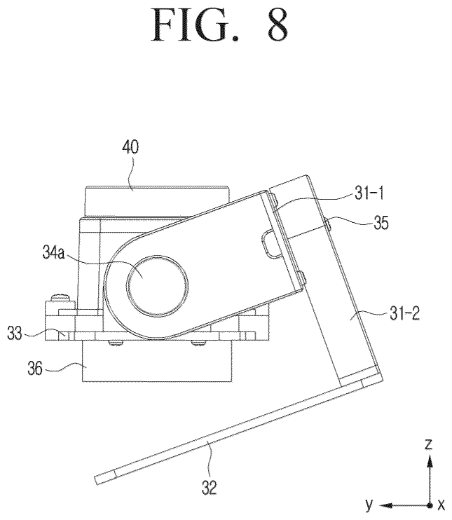

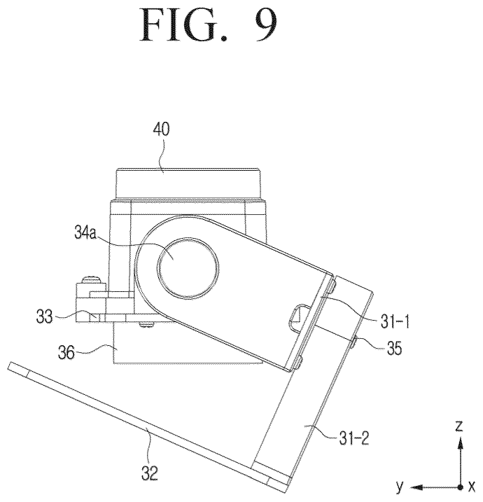

FIG. 8 and FIG. 9 are diagrams for illustrating a method for the electronic device 100 to maintain balance of the sensor 40 when a pitch angle of the body 10 changes according to one or more embodiments of the disclosure.

As explained through FIG. 3 and FIG. 4, the body 10 may be tilted forward or backward according to the moving direction of the electronic device 100. Accordingly, the pitch angle of the body 10 may change in a positive direction or a negative direction. The polarity of the pitch angle may vary according to the arrangement direction of the sensor for measurement of a pitch angle or the polarity of an electric signal. Here, the pitch angle and the roll angle of the body 10 may be detected based on sensing values of the sensor. Detailed explanation in this regard will be described in the parts described below.

As explained through FIG. 3, the body 10 may rotate in the rear direction of the body 10. Here, referring to FIG. 8, the body part 31 of the sensor module 30 may rotate in the rear direction of the body 10 following the body 10.

Here, the support part 33 that is rotatably connected to the body part 31 can maintain the balance by the balance element 36. In other words, the support part 33 may rotate in an opposite direction to the direction in which the body 10 is tilted based on the body part 31, i.e., the front direction of the body 10. Here, the size of the angle by which the support part 33 rotated in the front direction of the body 10 based on the body part 31 may be the same as the size of the angle by which the body 10 rotated in the rear direction of the body 10.

For example, in case the body 10 rotated by 10 degrees in the rear direction of the body 10 based on the ground surface, the body part 31 may rotate by 10 degrees in the rear direction of the body 10 based on the ground surface. Here, the support part 33 may rotate by 10 degrees in the front direction of the body 10 based on the body part 31.

As explained through FIG. 4, the body 10 may rotate in the front direction of the body 10. Here, referring to FIG. 9, the body part 31 of the sensor module 30 may rotate in the front direction of the body 10 following the body 10.

Here, the support part 33 rotatably connected to the body part 31 can maintain the balance without rotating based on the ground surface. In other words, the support part 33 may rotate in the rear direction of the body 10 based on the body part 31. Here, the size of the angle by which the support part 33 rotated in the rear direction of the body 10 based on the body part 31 may be the same as the size of the angle by which the body 10 rotated in the front direction of the body 10.

For example, the body 10 may rotate by 10 degrees in the front direction of the body 10 based on the ground surface. Here, the support part 33 may rotate by 10 degrees in the rear direction of the body 10 based on the body part 31.

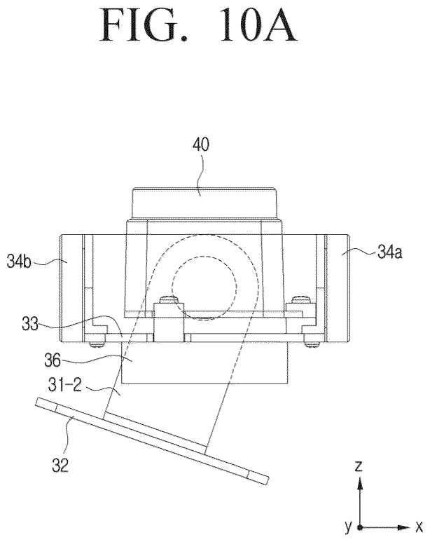

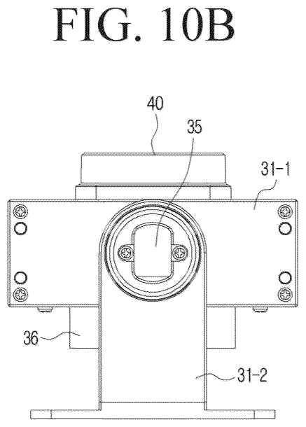

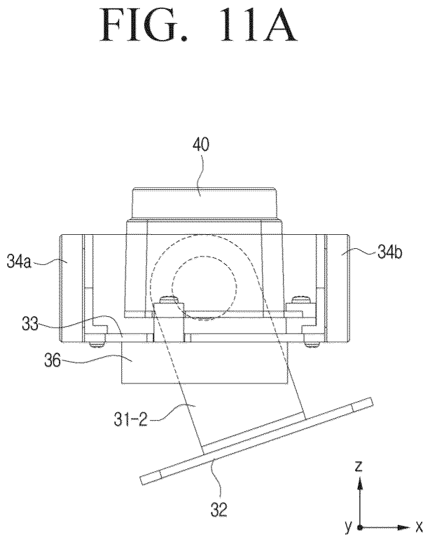

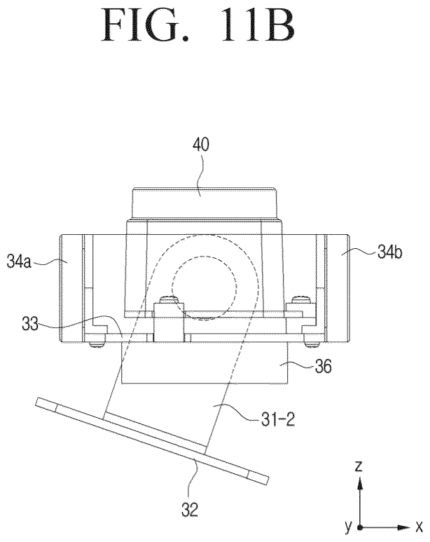

FIG. 10A, FIG. 10B, FIG. 11A, and FIG. 11B are diagrams for illustrating a method for the electronic device 100 to maintain balance of the sensor 40 when the body 10 is tilted in a roll angle direction according to one or more embodiments of the disclosure.

As explained through FIG. 5, the body 10 may rotate in the right direction of the body 10. Here, referring to FIG. 10A and FIG. 10B, the body part 31 of the sensor module 30 may rotate in the right direction of the body 10 following the body 10.

Here, the support part 33 rotatably connected to the body part 31 can maintain the balance without rotating based on the ground surface. In other words, the support part 33 may rotate in the left direction of the body 10 by the second hinge 35 based on the body part 31. Here, the size of the angle by which the support part 33 rotated in the left direction of the body 10 based on the body part 31 may be the same as the size of the angle by which the body 10 rotated in the right direction of the body 10.

For example, in case the body 10 rotated by 10 degrees in the right direction of the body 10 based on the ground surface, the body part 31 may rotate by 10 degrees in the right direction of the body 10 based on the ground surface. Here, the support part 33 may rotate by 10 degrees in the left direction of the body 10 based on the body part 31.

As explained through FIG. 6, the body 10 may rotate in the left direction of the body 10. Here, referring to FIG. 11A and FIG. 11B, the body part 31 of the sensor module 30 may rotate in the left direction of the body 10 following the body 10.

Here, the support part 33 rotatably connected to the body part 31 can maintain the balance without rotating based on the ground surface. In other words, the support part 33 may rotate in the right direction of the body 10 by the second hinge 35 based on the body part 31. Here, the size of the angle by which the support part 33 rotated in the right direction of the body 10 based on the body part 31 may be the same as the size of the angle by which the body 10 rotated in the left direction of the body 10.

For example, in case the body 10 rotated by 10 degrees in the left direction of the body 10 based on the ground surface, the body part 31 may rotate by 10 degrees in the left direction of the body 10 based on the ground surface. Here, the support part 33 may rotate by 10 degrees in the right direction of the body 10 based on the body part 31.

In the configuration of the sensor module 30 as above, the first hinge 34a, 34b and the second hinge 35 may further include a lubricant or a bearing, etc. such that a frictional force can be minimized.

Meanwhile, the body 10 may rotate by greater than or equal to a rotation angle that can be compensated by the support part 33. Here, the rotation angle may mean an angle by which the body 10 rotated per unit time.

That is, in case the body 10 rotates rapidly, a problem that the support part 33 also rotates following the body 10 based on the ground surface may occur. In other words, a problem that the support part 33 rotatably connected to the body part 31 of the sensor module 30 cannot rotate as much as the body 10 rotated in an opposite direction to the direction in which the body 10 rotated may occur. In this case, an additional component for maintaining the balance of the support part 33 may be further needed other than the balance element 36.

According to another embodiment of the disclosure, a tilt of the support part on which the sensor 40 is mounted can be detected by using a tilt detection sensor, and a tilt can be prevented or suppressed by using a magnetic force.

Specifically, the sensor module 30 may include a tilt detection sensor. The tilt detection sensor may be implemented in various forms such as an acceleration sensor, a gyro sensor, a geomagnetic sensor, an inertia measurement sensor 40, etc. Here, the electronic device 100 may detect rotations of the support part on which the sensor 40 is mounted based on sensing values of the at least one sensor. Here, the rotations of the support part may include rotations in the front/rear direction and the right/left direction of the body 10.

As an example, in case an acceleration sensor is included, the acceleration sensor may include a two-axis or a three-axis flux gate. In case a two-axis flux gate is used, the two flux gates, i.e., the X axis flux gate and the Y axis flux gate are arranged in a direction of being orthogonal to each other. Each flux gate includes a magnetic core, a driving coil wound around it, and a detection coil. The driving coil performs a role of exciting the magnetic core, and the detection coil performs a role of detecting an electromotive force induced from magnetivity generated from the magnetic core by driving of the driving coil. In such a configuration, the electromotive forces detected from the X axis flux gate and the Y axis flux gate may have different polarities and sizes according to the tilting directions and the tilting degrees of each axis flux gate. The processor 120 may calculate the pitch angle and the roll angle of the body 10 based on the sizes of electric signals introduced from the detection coils of each axis flux gate. As a formula for calculating a pitch angle and a roll angle is already known, detailed description will be omitted.

If at least one of the pitch angle or the roll angle of the sensor 40 is changed, the processor 120 may identify that the sensor 40 rotated. When a rotation of the sensor 40 is detected, the processor 120 may maintain the balance of the support part 33 by applying a magnetic force to the support part 33 by using an electromagnet, or applying a rotational force to the support part 33 by using a rotation motor.

That is, in case the support part 33 cannot rotate as much as the body 10 rotated in an opposite direction to the direction in which the body 10 rotated based on the body part 31, the electronic device 100 according to the disclosure can maintain the balance of the support part 33 by rotating the support part 33 by using an electromagnet or a rotation motor, etc.

Specifically, the electronic device 100 may rotate the support part 33 in an opposite direction to the direction in which the support part 33 rotated based on the ground surface. Accordingly, the balance of the support part 33 can be maintained.

For example, if the support part 33 rotates by 5 degrees in the front direction of the body 10 based on the ground surface, the electronic device 100 may rotate the support part 33 by 5 degrees in the rear direction of the body 10 based on the ground surface.

The following diagram is a diagram for illustrating a method for the electronic device 100 to maintain balance of the support part 33 by rotating the support part 33 by using an electromagnet or a rotation motor.

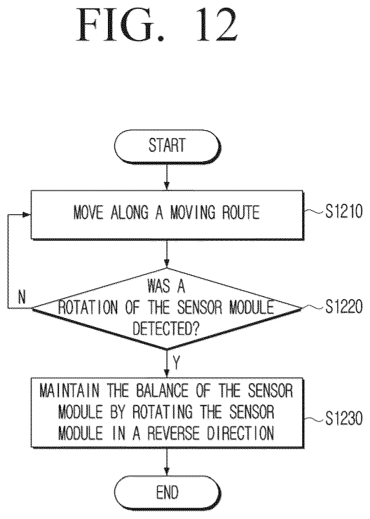

FIG. 12 is a flow chart for illustrating a method for the electronic device 100 to maintain balance of the support part 33 by rotating the support part 33 by using an electromagnet or a rotation motor according to one or more embodiments of the disclosure.

Referring to FIG. 12, the processor 120 may control the driving device 20 such that the electronic device 100 drives along a moving route in operation S1210. Specifically, if an event in which the electronic device 100 needs to move to a specific location within the space in which the electronic device 100 is located occurs, the processor 120 may set a moving route to the destination point based on the current location of the electronic device 100.

Here, the event in which the electronic device 100 needs to move to a specific location within the space may be an event in which a user input for moving the electronic device 100 to the destination point is obtained.

Alternatively, the event in which the electronic device 100 needs to move to a specific location within the space may be an event in which a predetermined time arrived, or a predetermined cycle arrived. Other than the above, a case in which a user instruction for executing the functions of the electronic device 100 (e.g., the cleaning function, the image projecting function, the serving function, etc.) is input may also be the event.

In case a user instruction is input through a user interface provided on the electronic device 100 or a remote control, etc., or the time counted at the timer becomes the predetermined time, the processor 120 may determine that an event in which the electronic device 100 needs to move to a specific location occurred. In this case, the processor 120 may set a moving route to the destination point based on the current location of the electronic device 100 based on the map information for the space stored in the memory 110. Then, the processor 120 may control the driving device 20 such that the electronic device 100 drives to the destination point.

However, the disclosure is not necessarily limited thereto, and the electronic device 100 may drive in a random direction without a moving route according to the use of the electronic device 100 or the characteristic of the used space, etc.

While the electronic device 100 is moving, the processor 120 may detect a rotation of the sensor 40 in operation S1220. As described above, the processor 120 may detect a rotation of the sensor 40 by using the tilt detection sensor. Alternatively, the processor 120 may receive information corresponding to a rotation of the senor 40 from an external device.

Meanwhile, the processor 120 according to the disclosure may detect a rotation of the sensor 40 through the tilt detection sensor, but this is merely one or more embodiments, and the processor 120 may detect a rotation of the sensor 40 by using information on an obstacle included in the map information stored in the memory 110 or information on the degree that an image obtained through the image sensor is tilted, etc.

If a rotation of the sensor 40 is not detected in operation S1220-N, the processor 120 may control the driving device 20 such that the electronic device 100 continues moving along the moving route in operation S1210.

If a rotation of the sensor 40 is detected in operation S1220-Y, the processor 120 may maintain the balance of the sensor 40 by rotating the sensor 40 in a reverse direction in operation S1230.

Specifically, the processor 120 may identify a target rotation angle for compensating a detected rotation angle of the sensor 40.

The processor 120 may detect a rotation in the pitch angle direction and/or a rotation in the roll angle direction of the sensor 40. In case the sensor 40 rotates in the pitch angle direction and/or the roll angle direction, the processor 120 may identify a target rotation angle for restoring the sensor 40 to the state before the rotation.

Here, the direction of the target rotation angle may be an opposite direction to the direction in which the sensor 40 rotated, and the size of the target rotation angle may be the same as the size of the angle by which the sensor 40 previously rotated.

For example, in case the sensor 40 rotates by 10 degrees in the front direction of the body 10, and rotates by 5 degrees in the right direction of the body 10 based on the ground surface, the target rotation angle may be 10 degrees in the rear direction of the body 10, and 5 degrees in the left direction of the body 10 based on the ground surface.

The processor 120 according to the disclosure may rotate the sensor 40 by using a magnetic element arranged on the support part 33, and an electromagnet arranged on the fixed plate 32.

According to one or more embodiments of the disclosure, at least one magnetic element may be arranged on the lower surface of the support part 33. Alternatively, at least one magnetic element may be arranged on the lower surface of the balance element 36. Alternatively, at least one magnetic element may be arranged inside the balance element 36.

Also, at least one electromagnet may be arranged in a location corresponding to the at least one magnetic element on the fixed plate 32.

When a rotation of the sensor 40 is detected, the processor 120 may grant a magnetic property to the at least one electromagnet by applying a current to the electromagnet. Accordingly, a repulsive force or an attractive force may be formed between the at least one magnetic element and the at least one electromagnet. Then, the repulsive force or the attractive force formed between the at least one magnetic element and the at least one electromagnet may rotate the support part. Here, the formed repulsive force or attractive force may rotate the support part in an opposite direction to the direction in which the support part rotated based on the ground surface. Also, the size of the rotation angle of the support part 33 by the formed repulsive force or attractive force may be the same as the size of the rotation angle by which the support part 33 rotated based on the ground surface.

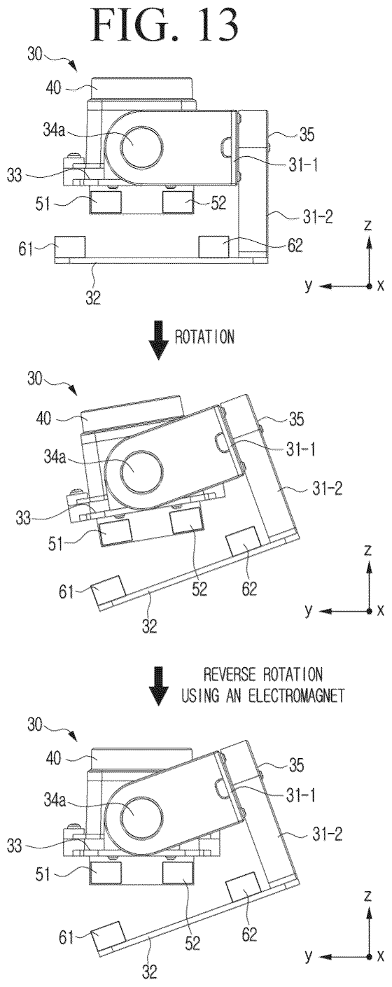

FIG. 13 is a diagram for illustrating a method for the electronic device 100 to rotate the sensor 40 in a reverse direction when the sensor 40 rotates in the rear direction of the body 10 according to one or more embodiments of the disclosure.

Referring to FIG. 13, at least one first magnetic element 51 may be arranged in the front edge area of the support part 33 based on the moving direction of the body 10 among the edge areas of the support part 33. Also, a second magnetic element 52 may be arranged in the rear edge area of the support part 33 based on the moving direction of the body 10 among the edge areas of the support part 33.

Then, a first electromagnet 61 may be arranged in the front edge area based on the moving direction of the body 10 among the edge areas of the fixed plate 32. Also, a second electromagnet 62 may be arranged in the rear edge area based on the moving direction of the body 10 among the edge areas of the fixed plate 32.

According to one or more embodiments of the disclosure, if it is detected that the sensor 40 is tilted to the rear side based on the moving direction of the body 10 (i.e., if the pitch angle of the sensor 40 changes to a negative direction), the processor 120 may apply a current to the second electromagnet 62 such that the second electromagnet 62 has a magnetic property of the same polarity as the second magnetic element 52. Accordingly, a repulsive force of pushing each other may be generated between the second electromagnet 62 and the second magnetic element 52. In this case, the support part 33 may rotate in a direction in which the second electromagnet 62 and the second magnetic element 52 get farther from each other. Here, the support part 33 may rotate in an opposite direction to the direction in which the support part 33 rotated based on the ground surface, and in the same rotation degree.

Alternatively, if it is detected that the sensor 40 is tilted to the rear side based on the moving direction of the body 10 (i.e., if the pitch angle of the sensor 40 changes to a negative direction), the processor 120 may apply a current to the first electromagnet 61 such that the first electromagnet 61 has a magnetic property of an opposite polarity to the first magnetic element 51. Accordingly, an attractive force of pulling each other may be generated between the first electromagnet 61 and the first magnetic element 51. In this case, the support part 33 may rotate in a direction in which the first electromagnet 61 and the first magnetic element 51 get closer to each other. Here, the support part 33 may rotate in an opposite direction to the direction in which the support part 33 rotated based on the ground surface, and in the same size of rotation.

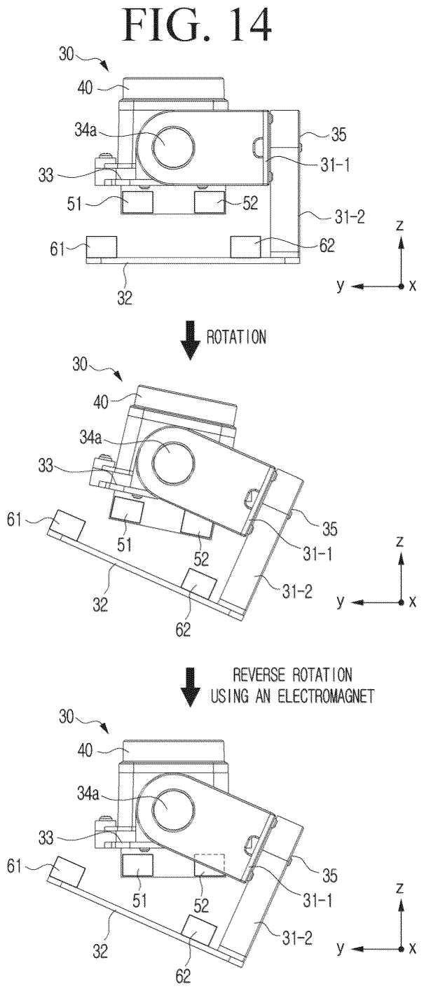

FIG. 14 is a diagram for illustrating a method for the electronic device 100 to rotate the sensor 40 in the rear direction of the body 10 when the sensor 40 rotates in the front direction of the body 10 according to one or more embodiments of the disclosure.

Referring to FIG. 14, if it is detected that the sensor 40 is tilted to the front side based on the moving direction of the body 10 (i.e., if the sensor 40 rotates in the positive direction of the pitch angle), the processor 120 may apply a current to the first electromagnet 61 such that the first electromagnet 61 has a magnetic property of the same polarity as the first magnetic element 51. Accordingly, a repulsive force of pushing each other may be generated between the first electromagnet 61 and the first magnetic element 51. In this case, the support part 33 may rotate in a direction in which the first electromagnet 61 and the first magnetic element 51 get farther from each other. Here, the support part 33 may rotate in an opposite direction to the direction in which the support part 33 rotated based on the ground surface.

Alternatively, if it is detected that the sensor 40 is tilted to the front side based on the moving direction of the body 10 (i.e., if the sensor 40 rotates in the positive direction of the pitch angle), the processor 120 may apply a current to the second electromagnet 62 such that the second electromagnet 62 has a magnetic property of an opposite polarity to the second magnetic element 52. Accordingly, an attractive force of pulling each other may be generated between the second electromagnet 62 and the second magnetic element 52. In this case, the support part 33 may rotate in a direction in which the second electromagnet 62 and the second magnetic element 52 get closer to each other. Here, the support part 33 may rotate in an opposite direction to the direction in which the support part 33 rotated based on the ground surface, and in the same size of rotation.

By a method similar to the aforementioned method, in case the support part 33 rotates in the roll angle direction, the electronic device 100 may perform an operation for compensating the rotation of the support part 33.

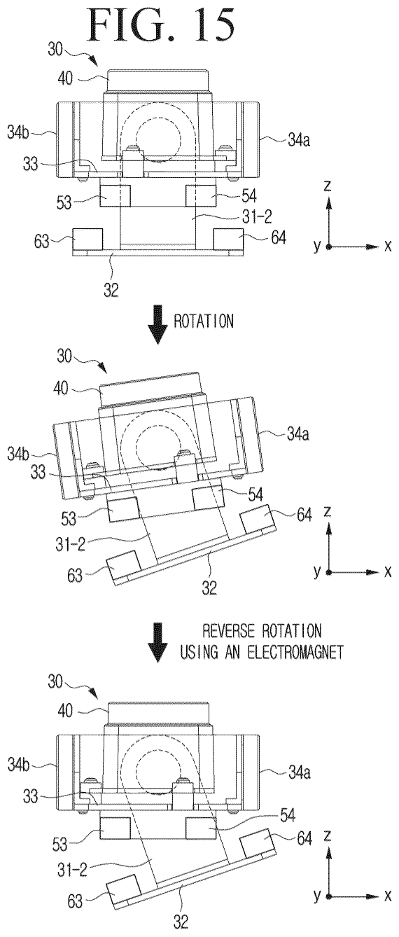

FIG. 15 is a diagram for illustrating a method for the electronic device 100 to rotate the sensor 40 in a reverse direction when the sensor 40 rotates in the right direction of the body 10 according to one or more embodiments of the disclosure.

Referring to FIG. 15, a third magnet element 53 may be arranged in the right edge area of the support part 33 based on the moving direction of the body 10 among the edge areas of the support part 33. Also, a fourth magnet element 54 may be arranged in the left edge area of the support part 33 based on the moving direction of the body 10 among the edge areas of the support part 33.

In addition, a third electromagnet 63 may be arranged in the right edge area based on the moving direction of the body 10 among the edge areas of the fixed plate 32. Also, a fourth electromagnet 64 may be arranged in the left edge area based on the moving direction of the body 10 among the edge areas of the fixed plate 32.

Referring to FIG. 15, if it is detected that the sensor 40 is tilted to the right side based on the moving direction of the body 10 (i.e., if the sensor 40 rotates in the positive direction of the roll angle), the processor 120 may apply a current to the fourth electromagnet 64 such that the fourth electromagnet 64 has a magnetic property of the same polarity as the fourth magnetic element 54. Accordingly, a repulsive force of pushing each other may be generated between the fourth electromagnet 64 and the fourth magnetic element 54. In this case, the support part 33 may rotate in a direction in which the fourth electromagnet 64 and the fourth magnetic element 54 get farther from each other. Here, the support part 33 may rotate in an opposite direction to the direction in which the support part 33 rotated based on the ground surface, and in the same size of rotation.

Alternatively, if it is detected that the sensor 40 is tilted to the right side based on the moving direction of the body 10 (i.e., if the sensor 40 rotates in the positive direction of the roll angle), the processor 120 may apply a current to the third electromagnet 63 such that the third electromagnet 63 has a magnetic property of an opposite polarity to the third magnetic element 53. Accordingly, an attractive force of pulling each other may be generated between the third electromagnet 63 and the third magnetic element 53. In this case, the support part 33 may rotate in a direction in which the third electromagnet 63 and the third magnetic element 53 get closer to each other. Here, the support part 33 may rotate in an opposite direction to the direction in which the support part 33 rotated based on the ground surface, and in the same rotation degree.

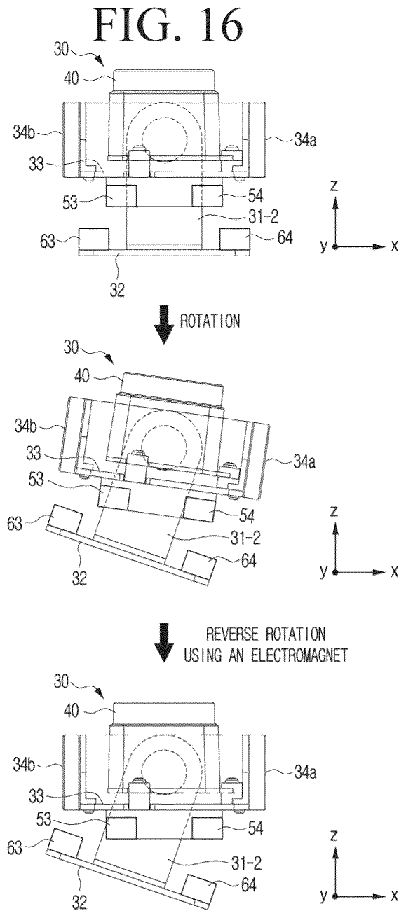

FIG. 16 is a diagram for illustrating a method for the electronic device 100 to rotate the sensor 40 in a reverse direction when the sensor 40 rotates in the left direction of the body 10 according to one or more embodiments of the disclosure.

Referring to FIG. 16, if it is detected that the sensor 40 is tilted to the left side based on the moving direction of the body 10 (i.e., if the roll angle of the sensor 40 changes to the negative direction), the processor 120 may apply a current to the third electromagnet 63 such that the third electromagnet 63 has a magnetic property of the same polarity as the third magnetic element 53. Accordingly, a repulsive force of pushing each other may be generated between the third electromagnet 63 and the third magnetic element 53. In this case, the support part 33 may rotate in a direction in which the third electromagnet 63 and the third magnetic element 53 get farther from each other. Here, the support part 33 may rotate in an opposite direction to the direction in which the support part 33 rotated based on the ground surface, and in the same rotation degree.

Alternatively, if it is detected that the sensor 40 is tilted to the left side based on the moving direction of the body 10 (i.e., if the roll angle of the sensor 40 changes to the negative direction), the processor 120 may apply a current to the fourth electromagnet 64 such that the fourth electromagnet 64 has a magnetic property of an opposite polarity to the fourth magnetic element 54. Accordingly, an attractive force of pulling each other may be generated between the fourth electromagnet 64 and the fourth magnetic element 54. In this case, the support part 33 may rotate in a direction in which the fourth electromagnet 64 and the fourth magnetic element 54 get closer to each other. Here, the support part 33 may rotate in an opposite direction to the direction in which the support part 33 rotated based on the ground surface, and in the same size of rotation.

Meanwhile, a current applied by the electronic device 100 to an electromagnet for rotating the support part 33 may correspond to the size of the target rotation value. That is, as the size of the target rotation value is bigger, the size of a current applied by the electronic device 100 to an electromagnet may be bigger.

Meanwhile, according to what was described above, when a rotation of the sensor 40 is detected, the electronic device 100 makes the sensor 40 rotate reversely by applying a current to an electromagnet. However, this is merely an example, and the electronic device 100 according to the disclosure may make the sensor 40 rotate reversely by using a rotation motor.

Meanwhile, according to one or more embodiments of the disclosure, the sensor module 30 may further include a rotation motor for rotating the support part 33. The electronic device 100 according to the disclosure can maintain the balance of the support part 33 by rotating the support part 33 by using the rotation motor.

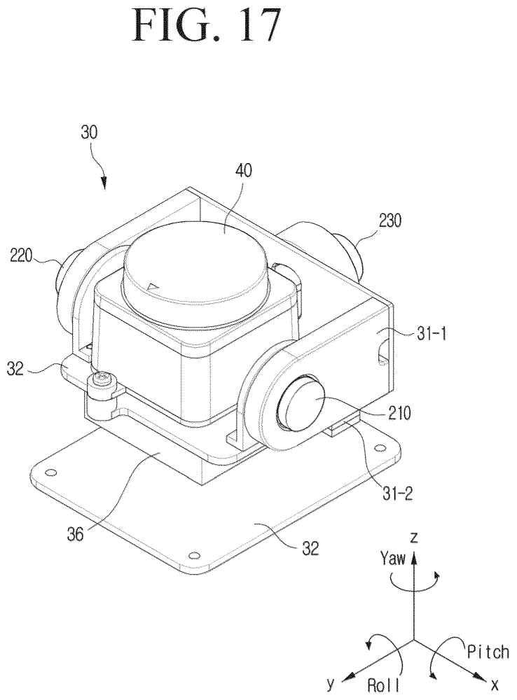

FIG. 17 is a diagram for illustrating a rotation motor according to one or more embodiments of the disclosure.

Referring to FIG. 17, the sensor module 30 may further include a first rotation motor 210, 220 for rotating the support part 33 in the pitch angle direction, and a second rotation motor 230 for rotating the support part 33 in the roll angle direction. The processor 120 may rotate the support part 33 such that the balance of the support part 33 is maintained by controlling the rotation motor.

Here, the direction and the size in which the electronic device 100 rotates the support part 33 by using the rotation motor may be the same as those in the method explained with reference to FIG. 12 to FIG. 16.

Specifically, if a rotation of the sensor 40 in the pitch angle direction and/or the roll angle direction is detected, the processor 120 may rotate the support part 33 by an opposite angle to the detected rotation angle in the pitch angle direction and/or the roll angle direction. Then, the electronic device 100 may rotate the support part 33 in the same size as the size of the detected rotation angle in the pitch angle direction and/or the roll angle direction.

Specifically, if it is detected that the sensor 40 is tilted to the front side based on the moving direction of the body 10 (i.e., if the support part 33 rotates in the positive direction of the pitch angle), the processor 120 may control the first rotation motor 210, 220 such that the sensor 40 rotates to the rear side based on the moving direction of the body 10 (i.e., such that the support part 33 rotates in the negative direction of the pitch angle).

Alternatively, if it is detected that the sensor 40 is tilted to the rear side based on the moving direction of the body 10 (i.e., if the support part 33 rotates in the negative direction of the pitch angle), the processor 120 may control the first rotation motor 210, 220 such that the sensor 40 rotates to the front side based on the moving direction of the body 10 (i.e., such that the support part 33 rotates in the positive direction of the pitch angle).

Alternatively, if it is detected that the sensor 40 is tilted to the right side based on the moving direction of the body 10 (i.e., if the support part 33 rotates in the positive direction of the roll angle), the processor 120 may control the second rotation motor 230 such that the sensor 40 rotates to the left side based on the moving direction of the body 10 (i.e., such that the support part 33 rotates in the negative direction of the roll angle).

Alternatively, if it is detected that the sensor 40 is tilted to the left side based on the moving direction of the body 10 (i.e., if the support part 33 rotates in the negative direction of the roll angle), the processor 120 may control the second rotation motor 230 such that the sensor 40 rotates to the right side based on the moving direction of the body 10 (i.e., such that the support part 33 rotates in the positive direction of the roll angle).

For example, in case the sensor 40 rotated by 10 degrees in the front direction of the body 10, and rotated by 5 degrees in the right direction of the body 10, the electronic device 100 may rotate the sensor 40 by 10 degrees in the rear direction of the body 10 through the first rotation motor 210, 220, and rotate the sensor 40 by 5 degrees in the left direction of the body 10 through the second rotation motor 230.

Meanwhile, the aforementioned operation of rotating the support part 33 through the electromagnet and operation of rotating the support part 33 through the rotation motor according to the disclosure can be performed together.

Meanwhile, there may be limitations on the aforementioned size of an angle by which the support part 33 can be rotated through the electromagnet and size of an angle by which the support part 33 can be rotated through the rotation motor.

Accordingly, if a rotation of the sensor module 30 is detected through the sensor module 30, the electronic device 100 may rotate the support part 33 by a first angle through the electromagnet, and rotate the support part 33 by a second angle through the rotation motor. Here, the sum of the first angle and the second angle may be the same as the rotation angle of the sensor module 30 detected through the sensor module 30.

Specifically, the processor 120 may identify whether the size of an angle by which the sensor module 30 rotated is greater than or equal to a predetermined angle. Here, if the size of the angle by which the sensor module 30 rotated is greater than or equal to the predetermined angle, a problem that the electronic device 100 cannot maintain the balance of the sensor module 30 just with one of the electromagnet or the rotation motor may occur. Here, the predetermined angle may be an angle by which the electronic device 100 can rotate the support part 33 through the electromagnet, or an angle by which the electronic device 100 can rotate the support part 33 through the rotation motor. Information on the predetermined angle may be stored in the memory 110.

Accordingly, if the size of an angle by which the sensor module 30 rotated that was detected through the sensor module 30 is greater than or equal to the predetermined angle, the processor 120 may rotate the support part 33 by the first angle through the electromagnet, and rotate the support part 33 by the second angle through the rotation motor. Here, the sum of the first angle and the second angle may be the same as the size of the angle by which the sensor module 30 rotated that was detected through the sensor module 30.

Meanwhile, it was explained that the sensor module 30 is controlled by the processor 120 of the electronic device 100, but the disclosure is not limited thereto. According to one or more embodiments of the disclosure, the sensor module 30 may include memory and a processor. The memory included in the sensor module 30 may be a component for storing various kinds of software, instructions, data, etc. necessary for the operations of the electronic device 100. Also, the processor included in the sensor module 30 is a component for controlling the overall operations of the sensor module 30.

The operation of the processor 120 of the electronic device 100 described above may be performed by the processor included in the sensor module 30. That is, the processor included in the sensor module 30 may detect a rotation of the sensor 40, and make the sensor 40 rotate reversely by controlling the electromagnet or the motor according to the detected rotation of the sensor 40. Here, the operation of detecting a rotation of the sensor 40, and making the sensor 40 rotate reversely may be the same as the operation performed by the processor of the electronic device 100.

Meanwhile, according to one or more embodiments of the disclosure, the sensor module 30 may further include a projector part.

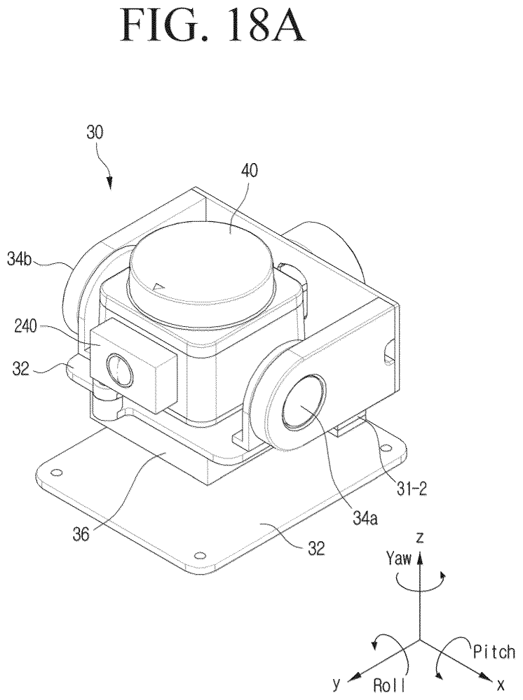

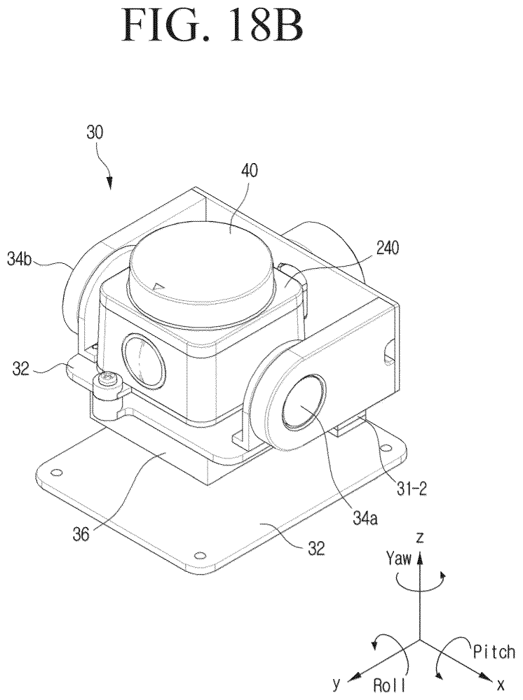

FIG. 18A and FIG. 18B are diagrams for illustrating a projector part according to one or more embodiments of the disclosure.

Referring to FIG. 18A, to one side of the sensor module 30 of the disclosure, a projector part 240 may be attached (or, connected). Here, the projector part 240 may be implemented by being able to be attached to or detached from the sensor module 30.

Referring to FIG. 18B, the sensor module 30 may further include a projector part 240. The projector part 240 may be a component for projecting an image.

According to one or more embodiments of the disclosure, the processor 120 may control the driving device 20 such that the electronic device 100 moves to a location spaced from a projection surface by a predetermined distance.

Here, information on the space in which the electronic device 100 is located and information on the projection surface may be stored in the memory 110. Based on the current location of the electronic device 100 and the information on the projection surface, the processor 120 may set a moving route such that the electronic device 100 moves to a location spaced from the projection surface by the predetermined distance, and control the driving device 20 such that the electronic device 100 moves along the set moving route.

The projector part 240 may be attached to one side of the sensor module 30 or supported by the support part 33. Accordingly, the projector part 240 may move by being interlocked with the movement of the support part 33.

Here, the processor 120 can maintain the balance of the projector part 240 by the same method as the method for maintaining the balance of the sensor module 30. That is, the balance of the projector part 240 can be maintained by at least one of the balance element, the magnetic element, the electromagnet, or the rotation motor according to the aforementioned embodiments.

Accordingly, in case an image is projected through the projector part 240 during moving, the electronic device 100 according to the disclosure can maintain the balance of the projector part 240 such that the projector part 240 can project the image stably.

In the above, each of various embodiments was explained, but each embodiment is not necessarily implemented separately, and it may be combined with at least one other embodiment entirely or partially, and implemented in one product together. For example, the electronic device 100 including the rotation motors 210, 220, 230 in FIG. 17, and the electronic device 100 including the projector part 240 in FIG. 18 were illustrated separately, but the electronic device 100 according to the disclosure may include the rotation motors 210, 220, 230 and the projector part 240 together.

Meanwhile, the term “a part” or “a module” used in the disclosure may include a unit implemented as hardware, software, or firmware, and may be interchangeably used with, for example, terms such as a logic, a logical block, a component, or circuitry. In addition, “a part” or “a module” may be a component constituted as an integrated body or a minimum unit or a part thereof performing one or more functions. For example, a module may be constituted as an application-specific integrated circuit (ASIC).

Also, the various embodiments of the disclosure may be implemented as software including instructions stored in machine-readable storage media (e.g.: computers). The machines refer to devices that call instructions stored in a storage medium, and can operate according to the called instructions, and the devices may include the electronic device 100 according to the aforementioned embodiments. In case an instruction is executed by a processor, the processor may perform a function corresponding to the instruction by itself, or by using other components under its control. An instruction may include a code that is generated or executed by a compiler or an interpreter. A machine-readable storage media may be provided by a non-transitory storage medium. Here, the term ‘non-transitory’ only means that the storage medium does not include a signal, and is tangible, and does not distinguish a case in which data is stored semi-permanently in a storage medium and a case in which data is stored temporarily.

In addition, according to one or more embodiments, methods according to the various embodiments described in the disclosure may be provided while being included in a computer program product. A computer program product can be traded as a product between a seller and a buyer. A computer program product may be distributed by a machine-readable storage media (e.g.: compact disc read only memory (CD-ROM)), or may be distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, each of the components (e.g.: a module or a program) according to the various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Also, operations performed by a module, a program, or other components according to the various embodiments may be executed sequentially, in parallel, repetitively, or heuristically. Or, at least some of the operations may be executed in a different order or omitted, or other operations may be added.

What is claimed is:

1. An electronic device comprising:
a main body;
a driving device configured to move the main body; and
a sensor module comprising:
at least one sensor;
a support that supports the at least one sensor;
a sensor module body fixing the sensor module to the main body;
a hinge part that rotatably connects the support and the sensor module body, wherein the hinge part comprises:
a first hinge rotatably supporting the support on sides of the support with respect to a front direction of the main body; and
a second hinge rotatably supporting the support on a rear side of the support with respect to the front direction of the main body; and
a balance element that is disposed on a lower side of the support, and configured to maintain a balance of the support while the main body is moved by the driving device.

2. The electronic device of claim 1, wherein the sensor module further comprises a projector part, the electronic device further comprising:
at least one processor; and
memory storing instructions, that when executed by the at least one processor, cause the at least one processor to:
control the driving device such that the electronic device moves to a location spaced from a projection surface by a predetermined distance; and
based on the main body moving to the location, reproduce content data stored in the memory, and control the projector part to project the reproduced content data.

3. The electronic device of claim 2,
wherein the driving device comprises two wheels connected to the main body,
wherein the sensor module body comprises:
a fixed plate fixed to the main body;
a first body part in which the first hinge is disposed; and
a second body part that is connected to the first body part through the second hinge, and is supported by the fixed plate,
wherein the first hinge is configured to, based on the main body rotating such that a pitch angle of the main body changes during moving of the main body, maintain the balance of the support while the main body rotates, and
wherein the second hinge is configured to, based on the main body rotating such that a roll angle of the main body changes during moving of the main body, maintain the balance of the support while the main body rotates.

4. The electronic device of claim 3,
wherein the sensor module further comprises:
a plurality of magnetic elements that are dispersed on a lower surface of the support; and
a plurality of electromagnets that are respectively disposed in locations corresponding to the plurality of magnetic elements on the fixed plate,
wherein the at least one sensor comprises a tilt detection sensor, and
wherein the instructions further cause the at least one processor to maintain the balance of the support by applying an electric signal to one of the plurality of electromagnets according to a tilt of the sensor module detected through the tilt detection sensor.

5. The electronic device of claim 3,
wherein the sensor module further comprises:
a first magnetic element disposed in a front edge area of the support based on the front direction of the main body among edge areas of the support;
a second magnetic element disposed in a rear edge area of the support based on the front direction of the main body among the edge areas of the support;
a first electromagnet disposed in a front edge area based on the front direction of the main body among edge areas of the fixed plate; and
a second electromagnet disposed in a rear edge area based on the front direction of the main body among the edge areas of the fixed plate,
wherein the at least one sensor of the sensor module comprises a tilt detection sensor, and
wherein the instructions further cause the at least one processor to:
based on detecting that the sensor module is tilted toward the front side of the main body through the tilt detection sensor, apply a first electric signal to the first electromagnet such that the first electromagnet has a same polarity as the first magnetic element; and
based on detecting that the sensor module is tilted toward the rear side of the main body through the tilt detection sensor, apply a second electric signal to the second electromagnet such that the second electromagnet has a same polarity as the second magnetic element.

6. The electronic device of claim 3,
wherein the sensor module further comprises:
a third magnetic element disposed in a right edge area of the support based on the front direction of the main body among edge areas of the support;
a fourth magnetic element disposed in a left edge area of the support based on the front direction of the main body among the edge areas of the support;
a third electromagnet disposed in a right edge area based on the front direction of the main body among edge areas of the fixed plate; and
a fourth electromagnet disposed in a left edge area based on the front direction of the main body among the edge areas of the fixed plate,
wherein the at least one sensor of the sensor module comprises a tilt detection sensor, and
wherein the instructions further cause the at least one processor to:
based on detecting that the sensor module is tilted toward a right side based on the front direction of the main body through the tilt detection sensor, apply a third electric signal to the third electromagnet such that the third electromagnet has a same polarity as the third magnetic element; and
based on detecting that the sensor module is tilted toward a left side based on the front direction of the main body through the tilt detection sensor, apply a fourth electric signal to the fourth electromagnet such that the fourth electromagnet has a same polarity as the fourth magnetic element.

7. The electronic device of claim 1,
wherein the sensor module further comprises:
a LiDAR sensor; and
a projector part, and
wherein the balance element comprises a balance weight configured to maintain a center of gravity of the sensor module by being heavier than weights of the LiDAR sensor and the projector part disposed on an upper side of the support.

8. A method of controlling an electronic device comprising a sensor module, the method comprising:
detecting a tilt of the sensor module based on a sensing value of a tilt detection sensor disposed in the sensor module during moving of the electronic device; and
maintaining a balance of the sensor module by applying an electric signal to at least one of a plurality of electromagnets comprised in the sensor module,
wherein the sensor module comprises:
a support supporting at least one sensor comprising the tilt detection sensor;
a sensor module body fixing the sensor module to a main body of the electronic device;
a hinge part that rotatably connects the support and the sensor module body; and
a balance element that is disposed on a lower side of the support, and is configured to maintain a balance of the support while the main body is moving by the driving device.

9. The method of claim 8,
wherein the sensor module comprises:
a plurality of magnetic elements that are dispersed in edge areas of the support; and
a plurality of electromagnets that are dispersed in edge areas of a fixed plate inside the sensor module body, and
wherein the balance element is configured to maintain the balance by:
based on detecting that the sensor module is tilted to one side based on a moving direction of the main body through the tilt detection sensor, maintain the balance of the sensor module by providing a magnetic force in an opposite direction to a direction in which the sensor module is tilted by applying an electric signal to an electromagnet in a tilted direction or an electromagnet on an opposite side thereof among the plurality of electromagnets.

10. The method of claim 8, wherein the sensor module comprises: a third magnetic element disposed in a right edge area of the support based on a moving direction of the main body among edge areas of the support; a fourth magnetic element disposed in a left edge area of the support based on the moving direction of the main body among the edge areas of the support; a third electromagnet disposed in a right edge area based on the moving direction of the main body among edge area of a fixed plate; and a fourth electromagnet disposed in a left edge area based on the moving direction of the main body among the edge areas of the fixed plate, the method further comprising:
based on detecting that the sensor module is tilted toward a right side based on the moving direction of the main body based on the sensing value of the tilt detection sensor, applying a third current to the third electromagnet such that the third electromagnet has a same polarity as the third magnetic element; and
based on detecting that the sensor module is tilted toward the left side based on the moving direction of the main body, applying a fourth current to the fourth electromagnet such that the fourth electromagnet has a same polarity as the fourth magnetic element.

11. A sensor module for mounting on an electronic device, comprising:
a support supporting at least one sensor;
a sensor module body fixing the sensor module to a main body of the electronic device;
a hinge part that rotatably connects the support and the sensor module body; and
a balance element that is disposed on a lower side of the support, and is configured to maintain a balance of the support while the electronic device is moving,
wherein the hinge part comprises:
a first hinge that rotatably supports the support on both sides of the support based on a front direction of the electronic device; and
a second hinge that rotatably supports the support on a rear side of the support based on the front direction of the electronic device.

12. The sensor module of claim 11, further comprising:
a projector part,
wherein the at least one sensor comprises a LiDAR sensor, and
wherein the balance element comprises a balance weight configured to maintain a center of gravity of the sensor module by being heavier than weights of the LiDAR sensor and the projector part disposed on an upper side of the support.

13. The sensor module of claim 11,
wherein the sensor module body comprises:
a fixed plate fixed to the main body of the electronic device;
a first body part in which the first hinge is disposed; and
a second body part that is connected to the first body part through the second hinge, and is supported by the fixed plate,
wherein the first hinge is configured to, based on the main body of the electronic device rotating such that a pitch angle of the main body of the electronic device changes during moving of the electronic device, maintain the balance of the support while the main body of the electronic device rotates, and
wherein the second hinge is configured to, based on the main body of the electronic device rotating such that a roll angle of the main body of the electronic device changes during moving of the main body of the electronic device, maintain the balance of the support while the main body of the electronic device rotates.

14. The sensor module of claim 13, further comprising:
a plurality of magnetic elements that are dispersed on a lower surface of the support; and
a plurality of electromagnets that are respectively disposed in locations corresponding to the plurality of magnetic elements on the fixed plate, and
wherein the plurality of electromagnets are configured to, based on the sensor module being tilted, provide a magnetic force to the support such that an attractive force is applied in an opposite direction to a direction in which the sensor module is tilted.

15. The sensor module of claim 13, further comprising:
a first magnetic element disposed in a front edge area of the support based on a front direction of the main body among edge areas of the support;
a second magnetic element disposed in a rear edge area of the support based on the front direction of the main body among the edge areas of the support;
a first electromagnet disposed in a front edge area based on the front direction of the main body among edge areas of the fixed plate;
a second electromagnet disposed in a rear edge area based on the front direction of the main body among the edge areas of the fixed plate;
a third magnetic element disposed in a right edge area of the support based on the front direction of the main body among the edge areas of the support;
a fourth magnetic element disposed in a left edge area of the support based on the front direction of the main body among the edge areas of the support;
a third electromagnet disposed in a right edge area based on the front direction of the main body among the edge areas of the fixed plate; and
a fourth electromagnet disposed in a left edge area based on the front direction of the main body among the edge areas of the fixed plate.
